(19) United States
(12) Patent Application Publication
(10) Pub. No.: US 2021/0110431 A1
(43) Pub. Date: Apr. 15, 2021

(54) MACHINE LEARNING SYSTEM FINDS UNITS OF INTEREST (UOI) BASED ON KEYWORDS, INTERESTS, AND BRANDS IN SOCIAL MEDIA AUDIENCES FOR THE PURPOSE OF TARGETING DIGITAL ADVERTISEMENTS

(71) Applicant: Clever Moe, Inc., Campbell, CA (US)

(72) Inventor: Frank COHEN, Campbell, CA (US)

(21) Appl. No.: 17/068,284

(22) Filed: Oct. 12, 2020

Related U.S. Application Data
(60) Provisional application No. 62/914,120, filed on Oct. 11, 2019.

(51) Int. Cl. G06Q 30/02; G06Q 50/00; G06N 20/00; G06N 5/04; G06F 3/0482

(52) U.S. Cl. CPC G06Q 30/0244; G06Q 50/01; G06Q 30/0201; G06Q 30/0277; G06F 3/0482; G06Q 30/0245; G06Q 30/0246; G06N 20/00; G06N 5/04; G06Q 30/0269

(57) ABSTRACT

A targeted advertising campaign may be developed by a server that received an identifier for a source resource associated with a social media platform for a digital advertising campaign. Source resources may be URLs and/or URI that provide a location of information stored on the Internet. Often times, the source resource is associated with a social medial platform. The source resource may be accessed and one or more units of interest (UOIs) may be collected therefrom. A UOI and an associated source resource may be associated together as a target audience. A set of target audiences may be generated and provided to a user, who may select one or more of the target audiences for the advertising campaign. The advertising campaign may be run and metrics regarding performance of the advertising campaign may be gathered. These metrics may be used to iteratively improve the advertising campaign.

### RELATED APPLICATION

This application is a NON-PROVISIONAL of, and claims priority to, U.S. Patent Application No. 62/914,120 entitled “MACHINE LEARNING SYSTEM FINDS UNITS OF INTEREST (UOI) BASED ON KEYWORDS, INTERESTS, AND BRANDS IN SOCIAL MEDIA AUDIENCES FOR THE PURPOSE OF TARGETING DIGITAL ADVERTISEMENTS” filed on 11 Oct. 2019, which is incorporated by reference in its entirety herein.

### FIELD OF INVENTION

The present invention relates to a computer method and system for targeting digital advertisements.

### BACKGROUND OF INVENTION

The Internet comprises a vast number of computers and computer networks that are interconnected through communication links. The interconnected computers exchange information using various services, including the World Wide Web and mobile applications. The Web and mobile applications allow a server computer system (a Web server or Web site) to send graphical Web pages of information to a remote client computer system. Each resource (computer, Web page, mobile application, file, device) of the Web is uniquely identified by a Uniform Resource Identifier (URI) and Uniform Resource Locator (URL). To view a specific Web page, a client computer system specifies the URL for that Web page in a request. The client system forwards the request to the Web server or mobile application that supports the Web page. The client computer system receives the Web page and displays the Web page using a browser or mobile application.

Social networks are a special category of application that run on the Internet using the Web and browsers and mobile applications. Social networks are a means for users to express themselves, share interests and experiences, and discover conversations. A social network provides users with a profile to be the source of their presence within a social network. A profile identifies the user, often by name, geographic location, interests, and links to their interaction on the social network. Users post text, video, photos, URLs to other Web content, and media to a social network. Users engage with posts by giving feedback to the social network through likes, shares, and comments. A social network notification mechanism alerts users to new postings and user engagement.

Social networks work well for organizations to market products, services, and events. Many social networks developed services for people to share interests, experiences, and recommendations for products and services. Advertisers use an advertising network operated by a social network to deliver marketing messages to users based on interests, keywords, and brands mentioned in their social discussions. As a result social networks are especially conducive to influencing purchase decisions.

The proliferation and popularity of social networks causes a difficulty for marketers when potential customers use multiple social networks to arrive at a purchasing decision. For example, a prospective customer on one social network becomes aware of a new product, uses a second social network to view the product being used, and a third social network to learn about product pricing and discount opportunities. Unfortunately, social networks usually act as walled gardens where the features of the social network and advertising network only work for the time a user is on the social network. When the user moves to the second social network there is no facility for tracking their engagement, interests, or decision to purchase.

Social networks each offer their own techniques and technology to find relevant discussions and people. The average marketer needs to learn and master each social network individually. People and entire audiences move frequently and rapidly between social networks.

### SUMMARY

A method and system for creating and/or modifying a targeted digital advertising campaign via communication between a client system and a server system over the Internet is herein described. The server system may receive one or more user defined and/or selected source resources in the form of, for example, uniform resource identifiers (URI) and/or uniform resource locators (URL) to social media discussions, posts, comments, replies, shares, profiles, Web pages, and text or word processor files resident on, for example, a social media platform. The server system may then build a machine learning model by collecting units of interest (UOIs) that may be keywords, interests, brands, and sentiments from the source resources. The server system collectors (e.g., searching mechanisms or spiders) may then search for and find additional source resources by following links and detecting references associated with the identifiers of the source resources. The server system may then generate and weight a model of the UOIs and transform the model into a set of target audiences that are likely to be interested in the advertiser's products and services. The server system may then send the client system the recommended target audiences and an advertising campaign proposal. The client system may receive and display the campaign proposal to the user who may, for example, enter a schedule, budget, and/or advertisements for the advertising campaign proposal. The client system may accept user preferences to categorize the proposed target audiences into positive (i.e., relevant) or negative (not relevant) categories. The server system may then receive the campaign proposal from the client system and interact with one or more social media advertising networks to create and run the ad campaign. The server system may observe the campaign and store campaign statistics including impressions, engagements, costs, and clicks. In some cases, the server system may continually retrain the model over time to incorporate all user feedback on the target audiences and the results of the advertising campaigns it runs.

An exemplary method for designing a targeted advertising campaign (sometimes referred to herein as a “digital advertising campaign” or an “advertising campaign”) may include receiving, by a server, an identifier for a source resource that may be associated with a social media platform for a digital advertising campaign. In some cases, the source resources are the inputs to train a machine learning model for a targeted advertising campaign.

The server may then collect one or more units of interest (UOIs) from the social media platform, a Web page, and/or a text file associated with the source resource. The collected UOIs and/or source resource may then be stored in a persistent data store. A rating (e.g., positive or negative) for each of the UOIs may then be determined and stored in the persistent data store. In some cases, determining a rating for a UOI may include analyzing content of each UOI based on a context of a discussion for the UOI on the source resource.

The server may then provide a set of positive target audiences to the user. A target audience may be a UOI and an associated source resource. A selection of one or more target audiences may then be received from the user and a digital advertising campaign may be generated using the selected target audiences. Advertisement from the digital advertising campaign may then be communicated to/across one or more social medial networks and/or digital advertising networks to the target audiences.

Advertising campaign results, or metrics, may be gathered from the digital advertising networks and provided to the user. Exemplary results include a number of impressions, a number of views, a degree of target audience engagement, a number of purchases, and a cost per click by advertisement. Additionally, or alternatively, the advertising campaign results may be used to improve the targeting of the digital advertising campaign.

Optionally, an indication of the user's negative or positive feedback on the advertising campaign, UOIs, and/or the target audiences may be received and the advertising campaign may be updated using the user's feedback. In some embodiments, user input on the efficacy of a digital advertisement campaign may be received, associated with the source resource and/or a UOI, and used to update the digital advertising campaign.

### BRIEF DESCRIPTION OF THE FIGURES

The present invention is illustrated by way of example, and not limitation, in the figures of the accompanying drawings in which:

FIG. 1 is a block diagram of an exemplary system for designing a targeted advertising campaign that may be run on, and/or cooperate with, a social media platform and/or a social medial advertising platform, in accordance with an embodiment of the present invention;

FIGS. 2A and 2B provide a flowchart of a process for designing a targeted advertising campaign that may be run on, and/or cooperate with, a social media platform and/or a social medial advertising platform, in accordance with an embodiment of the present invention;

FIGS. 3A and 3B provide a flowchart of another exemplary process for designing a targeted advertising campaign that may be run on, and/or cooperate with, a social media platform and/or a social medial advertising platform, in accordance with an embodiment of the present invention;

FIGS. 4A and 4B provide screen shots graphic user interface GUIs that provide a user with information as well as opportunities to enter information and make selections that are received by a server when designing a targeted advertising campaign, in accordance with an embodiment of the present invention;

FIG. 5 provides a block diagram of an embodiment of the present invention, in accordance with an embodiment of the present invention.

Throughout the drawings, the same reference numerals and characters, unless otherwise stated, are used to denote like features, elements, components, or portions of the illustrated embodiments. Moreover, while the subject invention will now be described in detail with reference to the drawings, the description is done in connection with the illustrative embodiments. It is intended that changes and modifications can be made to the described embodiments without departing from the true scope and spirit of the subject invention as defined by the appended claims.

### WRITTEN DESCRIPTION

The present invention provides a method and system for targeting digital advertising campaigns on the Internet. The targeting system of the present invention increases advertisement engagement and response to marketing offers across one or more digital advertising and/or social networks.

In one embodiment, the server system assigns a unique client identifier to each user of the system. A user of the client system uses the system to identify source resources by Uniform Resource Identifier (URI) or Uniform Resource Locator (URL) that are present in, for example, discussions, posts, comments, replies, shares, profiles, Web pages, and text or word processor files that are present on a plurality of different social media platforms. The server system receives the source resources and builds a machine learning model by collecting Units of Interest (UOI) that are present on the social media platforms.

UOIs may be, for example, keywords, interests, brands, and sentiments a user of a social media platform associates with his or her social media account. For the sake of clarity, a user of a social media platform or service may be referred to herein as a “target.” The server system collectors find additional source resources by following links and detecting references within the source resources. The server system weighs the resulting model and transforms the model into a set of target audiences (i.e., social media users and/or social media account holders) that are likely interested in the advertiser's products and/or services. The server system sends the client system the recommended target audiences and an advertising campaign proposal. The client system receives and displays the campaign proposal to a user who may enter a schedule, budget, and/or ad definitions for the ad campaign proposal into the client system.

Ads included in an ad campaign proposal may include, for example, a photograph, video, headline message, ad message, a link to a landing page, or other media advertising one or more products/services. The user may enter and/or accept the user preferences for categorizing the proposed target audiences into positive, negative, and not relevant categories and a campaign proposal may be generated with this information, which may be communicated to the server system, which may receive the campaign proposal and interact with one or more social media advertising networks to create and run the ad campaign. The server may compose the ads for the ad campaign according to each social media advertising network requirements. Once the campaign is launched, the server system may monitor the campaign and store statistics about the campaign including impressions, engagements, costs, and clicks. The server system continually retrains the model over time to incorporate all user feedback on the target audiences and the results of the advertising campaigns it runs.

In some embodiments, once the user identifies, or generates, an ad campaign the user only needs to use the client system to organize, direct, and manage targeted advertising campaigns across one or more social media ad networks. The ad campaign provides targeting ads for display to target audiences who have already expressed interest in the subject of the advertisement. The targeting performs A/B comparison testing of messages. The targeting model accuracy improves overtime as it incorporates more user and campaign results and results from the campaigns determine high targeting accuracy spread across multiple social media networks.

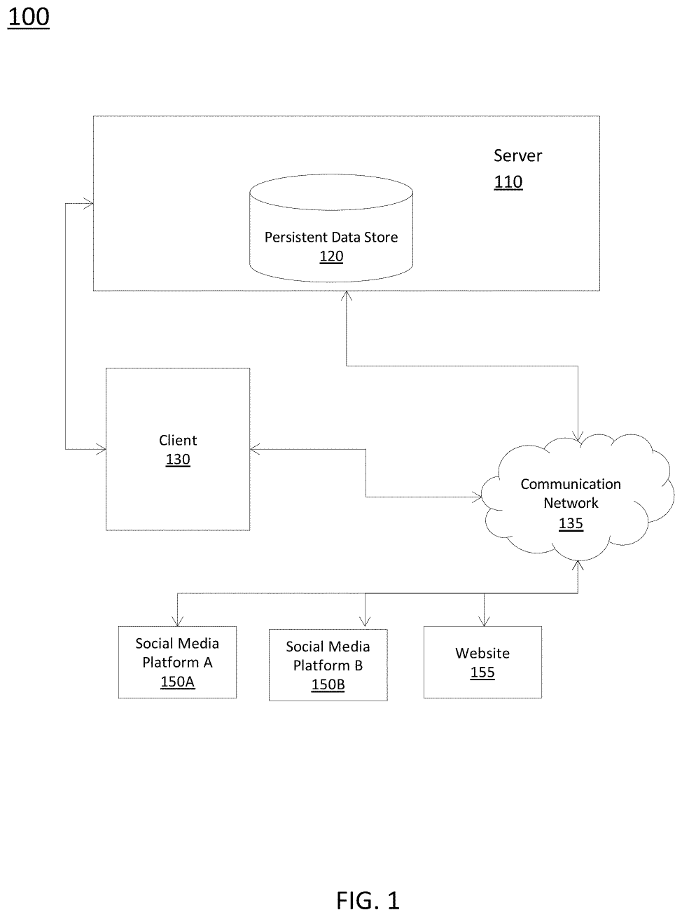

FIG. 1 is a block diagram of an exemplary system 100 for designing a targeted advertising campaign that may be run on, and/or cooperate with, a social media platform and/or a social medial advertising platform. System 100 includes a client computer 130 communicatively coupled to a server 110 via a communications network 135 like the Internet. Client computer 130 may be associated with a client identifier (e.g., username and password) and may be configured to communicate with server system 110 over communications network 135 via, for example, a Web browser software.

Server 110 may be configured to communicate with client computer 130 and one or more social media platforms such as social medial platform A 150A and social medial platform B 150B as well as one or more websites 155 via communication network 135 in order to, for example, extract or detect UOIs. Server 110 may include and/or be communicatively coupled to a persistent data store 120 configured to store, for example, UOIs, source resources, ratings, advertising campaign performance metrics, and other information related thereto. Additionally, or alternatively, server 110 may be configured to execute one or more of the processes described herein.

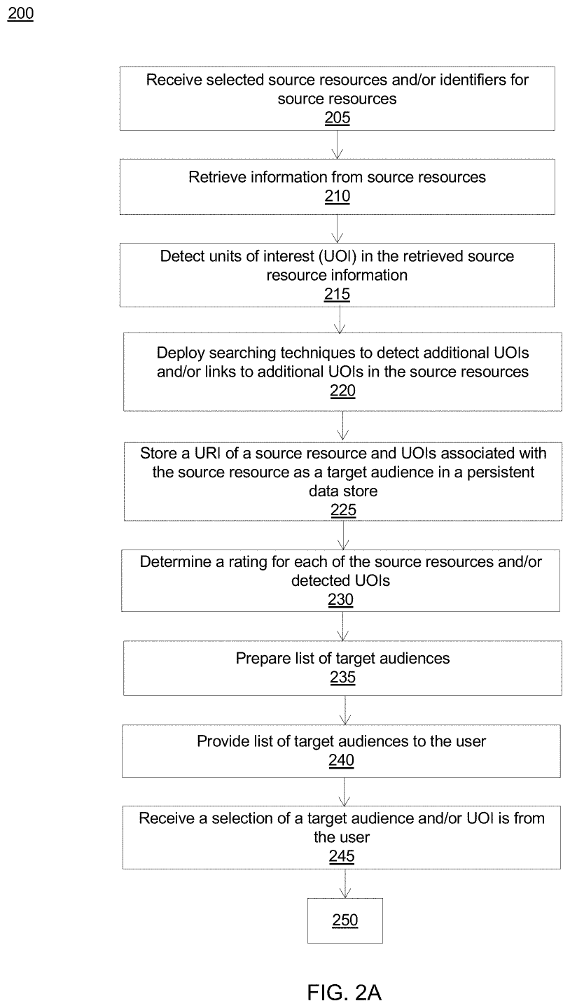

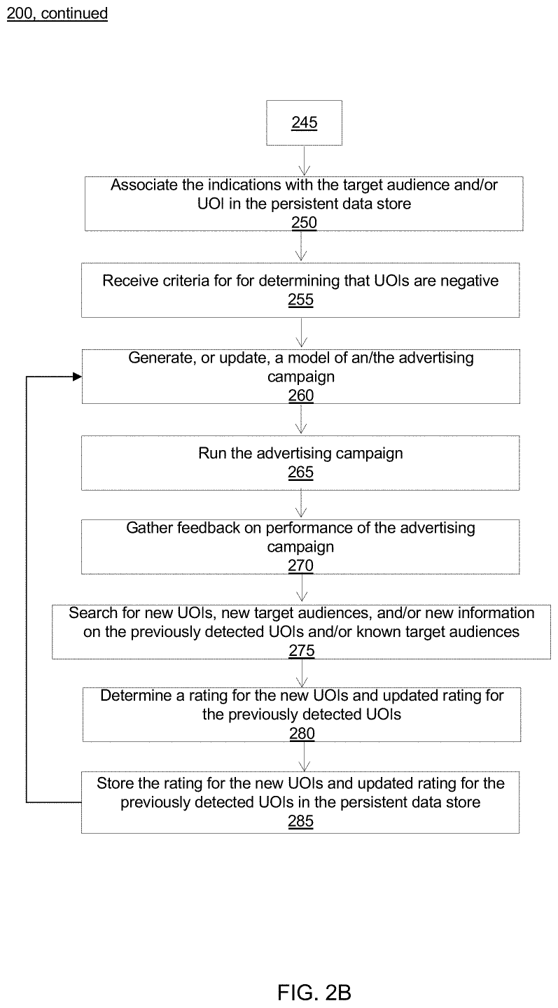

FIGS. 2A and 2B provide a flowchart of a process 200 for designing a targeted advertising campaign that may be run on, and/or cooperate with, a social media platform and/or a social medial advertising platform. In some instances, execution of process 200, or portions thereof, may utilize machine learning and/or iterative modeling to develop targeted advertising campaigns Process 200 may be executed by, for example, system 100 or a component thereof.

Initially, in step 205, selected source resources and/or identifiers for a selected source resource may be received from a user (e.g., an advertiser or marketing executive). In many cases, an identifier for a source resource may include a Uniform Resource Identifier (URI), a Uniform Resource Locator (URL), Hypertext Markup Language (HTML), JavaScript text, an Adobe Portable Document File (PDF), a word processor document, text, and/or images. Exemplary source resources include Web pages, social media posts, social media profiles, and lists of messages containing keywords, interests, and brands.

Optionally, in step 210, information may be retrieved from one or more of the source resources. In step 215, the source resources and/or information retrieved from the one or more source resources may be analyzed to detect one or more units of interest (UOI) associated with the respective source resources. Exemplary UOIs include, but are not limited to, keywords and phrases, interests, and brands. In some cases, step 215 is executed via a server searching and/or querying one or more social media platforms via an API, Web UI, and/or Web object. In some embodiments, execution of step 210 includes identifying a social media platform embedded in an identifier for the source resource and/or associated with the source resource.

In step 220, searching techniques may be deployed over, for example, the Internet to detect additional UOIs and/or links to additional UOIs that may be in, or are associated with, the source resources received in step 205. In some embodiments, step 220 may be executed using links found in and/or associated with the source resources. Additionally, or alternatively, in some cases, a server executing process 200 may have a set of preferences to indicate the depth and width of the searching techniques to be deployed in step 220. Additionally, or alternatively, the server system may allow users to set the depth and width values as an option when, for example, selecting source resources that are received instead 205.

UOIs detected via execution of step 215 and/or 220, and a URI to the location of the UOI, may then be stored in persistent data storage (step 225). In some embodiments, execution of step 225 includes bundling together a source resource and UOIs associated with the respective source resource together as a target audience and then storing the association as a target audience in the persistent data store. In step 230, a rating (e.g., positive or negative and/or a scale (e.g., 1-5 or 1-10)) may be associated with each of the source resources and/or UOIs. In some embodiments, execution of step 230 may be triggered by execution of step 225.

For example, if social media platform A 150A is Facebook then, execution of step 210 may include using a Facebook Graph API to collect UOIs (keywords, interests, and brands the collectors found in the source resources) for storage in the persistent data store (step 225). The stored UOIs may then be assigned a rating, which may also be stored in the persistent data store

In step 235, a list of target audiences may be prepared. At times, execution of step 235 may include filtering the available target audiences using their respective ratings. In some embodiments, preparation of the list of audiences may be responsive to one or more user preferences and/or parameters for target audiences. Additionally, or alternatively, execution of step 235 may include applying various techniques (e.g., transforms, weighting, statistical analysis) to the target audiences and/or UOIs so that, for example, UOIs with a positive rating are added to the list of target audiences.

In step 240, the prepared list of target audiences may be provided to the user via, for example, communication to a client computer, like client computer 130. In some embodiments, execution of step 240 may include provision of a live view of the target audiences that updates periodically (e.g., every 10, 20, 60, etc. seconds).

Then, in step 245, an indication that one or more target audiences and/or UOIs is selected may be received from of the user via, for example, client computer 130. The selected target audience and/or associated UOI and/or source resource may then be associated with a positive rating, which may be stored in the persistent data store. In some embodiments, the one or more selected target audiences may be added to an advertising campaign for the user.

In step 255, a user may then select criteria (e.g., poor results or target responses) for determining that UOIs and/or source resources are negative. UOIs and/or source resources that are determined to be negative may be selected go into a negative UOI dataset and/or have their rating adjusted (step 230). Optionally, following execution of step 255, step 215 and some subsequent steps may be repeated. The server system may continue to search for target audiences to, for example, continually update the list of source resources and found target audiences. The content of the persistent data store improves in targeting accuracy over time automatically.

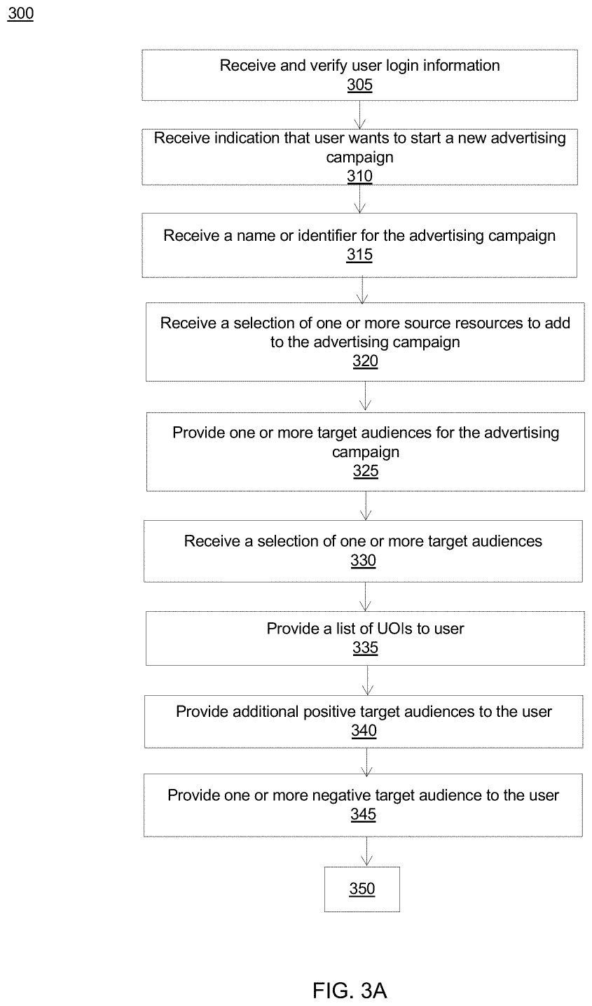

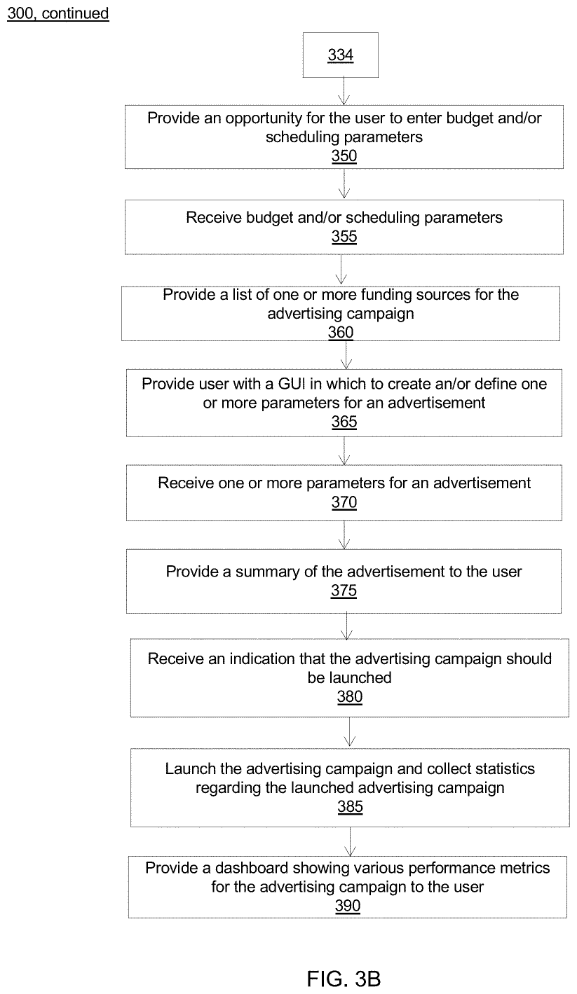

In step 260, a model of an advertising campaign may be generated using, for example, results from execution of one or more of steps 205-255. The model of the advertising campaign may include, for example, one or more target audiences, one or more social media platforms on which to launch and/or run the advertising campaign, and/or user parameters for the advertising campaign. Further details regarding exemplary user parameters are provided below with regard to the discussion of FIGS. 3A and 3B.

In step 265, the advertising campaign may be run on, for example, one or more social media platforms and/or advertising platforms and feedback regarding performance of the advertising campaign may be gathered (step 270). Exemplary gathered feedback includes, but is not limited to, impressions, engagements, costs, and clicks the advertisements included in the advertising campaign receive from potential customers.

In step 275, a search for new UOIs and/or target audiences pertaining to the source resources and/or target audiences may be executed. Additionally, or alternatively, execution of step 275 may include searching for new and/or updated information pertaining to known UOIs and/or target audiences. The information discovered via the search(es) of step 275 may be added to the persistent data store and/or added to the information about a known UOI and/or target audience in the data store. Step 275 may be executed on an as-needed and/or periodic basis in order to, for example, update the UOIs and/or target audiences for each advertising campaign and/or social media platform.

In step 280, a rating for the new UOIs and/or target audiences may be determined and the new rating may be stored in the persistent data store. Additionally, or alternatively, in step 280, a rating for the known UOIs and/or target audiences may be updated and the updated rating may be stored in the persistent data store. The result of execution of step(s) 265-285 may be used to update the model of the advertising campaign generated in step 260 via, for example, machine learning.

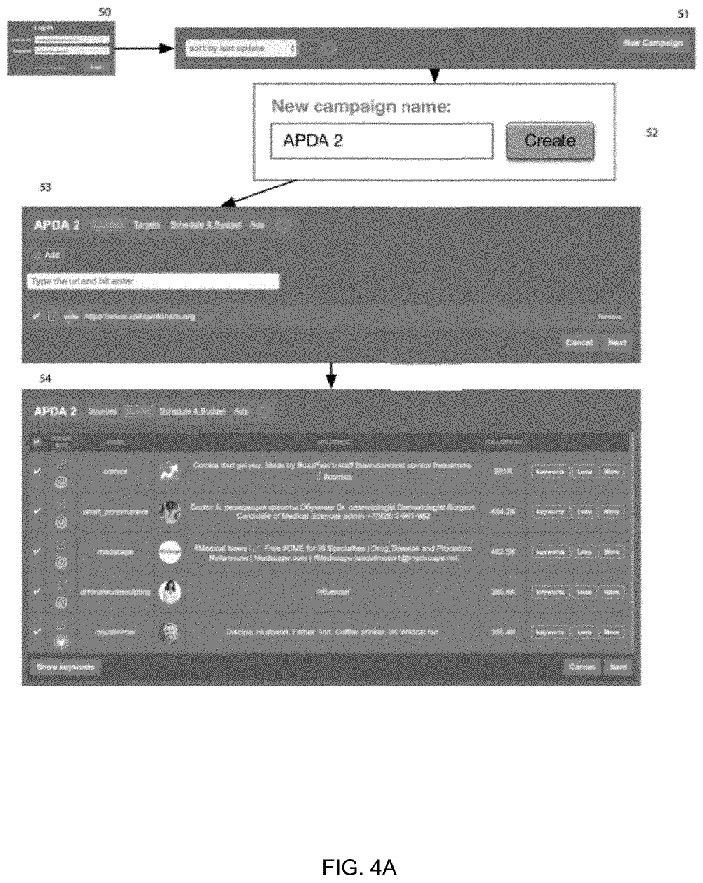

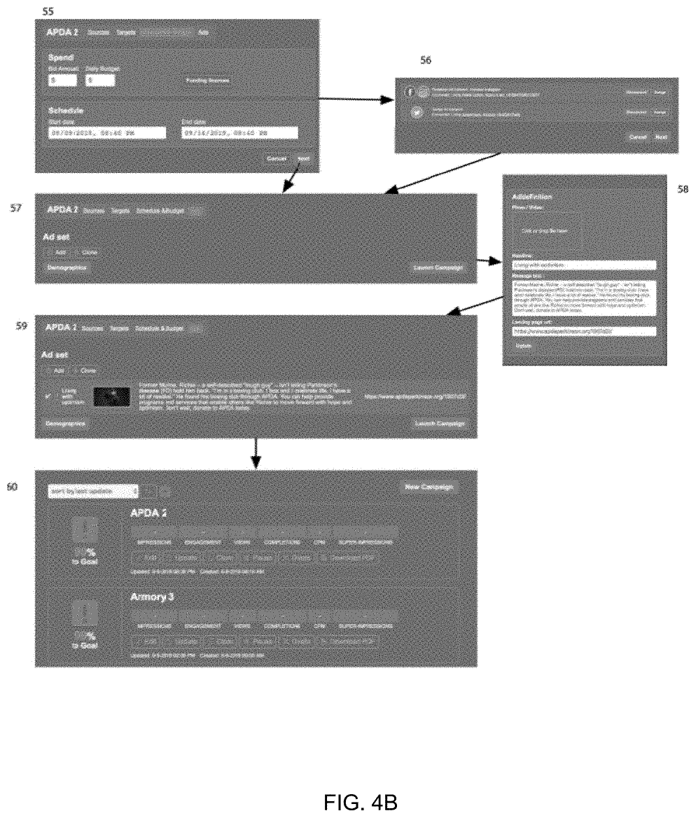

FIGS. 3A and 3B provide a flowchart of another exemplary process 300 for designing a targeted advertising campaign that may be run on, and/or cooperate with, a social media platform and/or a social medial advertising platform. Process 300 may be executed by, for example, system 100 or a component thereof and, in some instances, may utilize machine learning and/or iterative modeling to develop targeted advertising campaigns. Portions of process 300 are further explained by way of FIGS. 4A and 4B, which provide screen shots of exemplary graphic user interface GUIs that provide a user with information as well as opportunities to enter information and make selections that are received by a server such as server 110.

Using process 300, a user may identify target audiences, build, create, and/or run an advertising campaign. In step 305, a user may log into a server like server 110, or computer software program running on a client computer like client computer 130. The user may log into the server, client computer, and/or software program with identification and password credentials via a login GUI like login GUI 50 shown in FIG. 4A. Following a successful login, an indication that a user desires to start a new ad campaign and/or modify an existing ad campaign may be received (step 310) via, for example, selection of a new campaign button provided by a new campaign GUI 51 that provides a new campaign button.

An indication of a name or identifier for the advertising campaign may then be received (step 315) via, for example, the user typing text (in this case “APDA 2”) into a text box provided by a new campaign name GUI 52 and selecting the create button. A selection of one or more source resources to add to the new ad campaign may then be received (step 320). In some embodiments, the selected source resources may be received via, for example, the user entering an identifier of the source resource (e.g., URL, URI, brand name, etc.) into a text box provided by GUI 53. Additionally, the source received may be selected from a drop down menu of exemplary source resources provided by GUI 53 (not shown). Then, in step 325, one or more target audiences may be provided to the user via, for example, section of a target audiences button provided by GUI 53. The target audiences provided to the user in step 325 may be, for example, be websites, names, or organizations that positively match the source resources. The target audiences may be provided to the user in list form that may provide images, logos, or other information about the target audiences in addition to the name of each respective target audience as shown in GUI 54. A selection of target audiences for the campaign may then be received (step 330) via, for example, the user selecting a check-box corresponding to a selected target audience via GUI 54. Optionally, in step 335, a user may be provided with a list of UOIs associated with, for example, each of the target audiences and/or advertising campaign responsively to, for example, selection of one or more of the “keywords” and/or “show keywords” button(s) provided by GUI 54.

Optionally, in step 340, additional positive target audiences that may be associated with and/or correspond to a particular target audience may be provided to the user responsively to, for example, the user selecting a “more” button provided by GUI 54. Additionally, or alternatively, a user may optionally be provided with one or more negative target audiences (step 345) responsively to, for example, receipt of a user's selection of a “next” button provided by GUI 54.

In some embodiments, a user may optionally be provided with an opportunity to set parameters for a budget and/or schedule for the advertising campaign (step 350, which is shown in FIG. 3B) responsively to, for example, selection of a “schedule and budget” icon provided by GUI 55, which may trigger display of budget GUI 55. Then, scheduling and/or budget information for the advertising campaign may be received (step 355). Exemplary scheduling and/or budget information includes, but is not limited to, an overall ad campaign spending level, a daily maximum spending level, a schedule (e.g., a geographic location, a date range, and/or a time of day range) for displaying the advertisements of the ad campaign.

In step 360, a user may be provided with a list of one or more funding sources as shown in GUI 56 responsively to, for example, the set of a selection of a “funding sources” button that may be provided by GUI 55. Selections received via GUI 56 may enable, for example, users to connect the advertising campaign to, for example, a social media advertising account for internal and/or external billing purposes.

A user may then be provided with a GUI 57 by which the user may open a GUI 58 by which to create and/or define one or more parameters of an advertisement for the advertisement campaign (step 365). Then, an image, a headline, a message, and/or a landing page for the advertisement may be received (step 370) via, for example, the user's entry of information into GUI 58 and selection of an “update” button. A summary of the advertisement generated using the information entered into GUI 58 may then be provided to user (step 375) via, for example, GUI 59.

In step 380, an indication that the advertising campaign should be launched may be received via, for example, the user selection of a “launch campaign” button provided by GUI 59. In step 385, an indication that the advertising campaign should be launched may be received via, for example, the user selection of a “launch campaign” button provided by GUI 59. In step 385, a dashboard showing various performance metrics for the advertising campaign may be provided to the user via, for example, GUI 60, which shows the advertising campaign and statistics about the campaign including impressions, engagements, costs, and clicks.

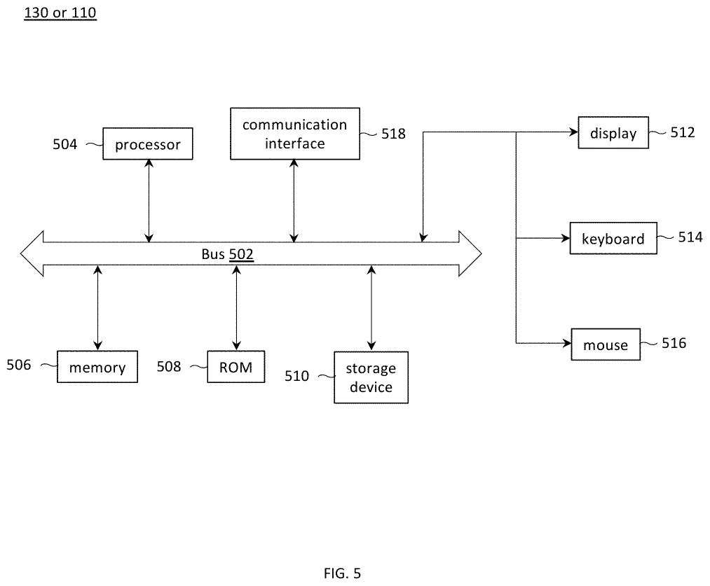

FIG. 5 is a block diagram showing a system 500 includes a bus 502 or other communication mechanism for communicating information, and a processor 504 coupled with the bus 502 for processing information. Computer system 500 also includes a main memory 506, such as a random-access memory (RAM) or other dynamic storage device, coupled to the bus 502 for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device coupled to the bus 502 for storing static information and instructions for the processor 504. A storage device 510, for example a hard disk, flash memory-based storage medium, or other storage medium from which processor 504 can read, is provided and coupled to the bus 502 for storing information and instructions (e.g., operating systems, applications programs and the like).

Computer system 500 may be coupled via the bus 502 to a display 512, such as a flat panel display, for displaying information to a computer user. An input device 514, such as a keyboard including alphanumeric and other keys, may be coupled to the bus 502 for communicating information and command selections to the processor 504. Another type of user input device is cursor control device 516, such as a mouse, a track pad, or similar input device for communicating direction information and command selections to processor 504 and for controlling cursor movement on the display 512. Other user interface devices, such as microphones, speakers, etc. are not shown in detail but may be involved with the receipt of user input and/or presentation of output.

The processes referred to herein may be implemented by processor 504 executing appropriate sequences of computer-readable instructions contained in main memory 506. Such instructions may be read into main memory 506 from another computer-readable medium, such as storage device 510, and execution of the sequences of instructions contained in the main memory 506 causes the processor 504 to perform the associated actions. In alternative embodiments, hard-wired circuitry or firmware-controlled processing units may be used in place of or in combination with processor 504 and its associated computer software instructions to implement the invention. The computer-readable instructions may be rendered in any computer language.

In general, all of the above process descriptions are meant to encompass any series of logical steps performed in a sequence to accomplish a given purpose, which is the hallmark of any computer-executable application. Unless specifically stated otherwise, it should be appreciated that throughout the description of the present invention, use of terms such as “processing”, “computing”, “calculating”, “determining”, “displaying”, “receiving”, “transmitting” or the like, refer to the action and processes of an appropriately programmed computer system, such as computer system 500 or similar electronic computing device, that manipulates and transforms data represented as physical (electronic) quantities within its registers and memories into other data similarly represented as physical quantities within its memories or registers or other such information storage, transmission or display devices.

Computer system 500 also includes a communication interface 518 coupled to the bus 502. Communication interface 518 may provide a two-way data communication channel with a computer network, which provides connectivity to and among the various computer systems discussed above. For example, communication interface 518 may be a local area network (LAN) card to provide a data communication connection to a compatible LAN, which itself is communicatively coupled to the Internet through one or more Internet service provider networks. The precise details of such communication paths are not critical to the present invention. What is important is that computer system 500 can send and receive messages and data through the communication interface 518 and in that way communicate with hosts accessible via the Internet. It is noted that the components of system 500 may be located in a single device or located in a plurality of physically and/or geographically distributed devices.

I claim:

1. A method comprising:
receiving, by a server, an identifier for a source resource associated with a social media platform for a digital advertising campaign;
collecting, by the server, one or more units of interest (UOIs) from the social media platform;
storing, by the server, the collected UOIs in a persistent data store;
determining, by the server, a positive or negative association for each of the UOIs;
providing, by the server, a set of positive target audiences to the user
receiving, by the server, a selection of positive target audiences from the user,
generating, by the server, a digital advertising campaign using the selected positive target audiences;
communicating, by the server, advertisements across one or more digital advertising networks to the target audiences;
gathering, by the server, advertising campaign results from the digital advertising networks;
providing, by the server, the gathered advertising campaign results to the user;
receiving, by the server, an indication of the user's negative or positive feedback on at least one of the advertising campaign and the target audiences; and
updating, by the server, the advertising campaign using the user's feedback.

2. The method of claim 1, further comprising:
collecting, by the server, additional UOIs and updating the advertising campaign using the additional UOIs.

3. The method of claim 1 wherein the source resources are the inputs to train a machine learning engine model.

4. The method of claim 1, wherein the server collects UOIs from at least one of a social media platform, a Web page, and a text file.

5. The method of claim 1 wherein the determining of a positive or negative association for each of the UOIs includes analyzing content of each UOI based on a context of a discussion for the UOI on the source resource.

6. The method of claim 1, further comprising:
receiving, by the server, user input on the efficacy of a digital advertisement campaign; and
associating, by the server, the user input with at least one of the source resource and UOIs; and
updating, by the server, the digital advertising campaign with the user input.

7. The method of claim 1, further comprising:
updating, by the server, the rating of one or more of the UOIs over time.

8. The method of claim 1, wherein the gathered advertising campaign results includes at least one of a number of impressions, a number of views, a degree of target audience engagement, a number of purchases, and a cost per click by advertisement.

9. The method of claim 1, wherein the gathered advertising campaign results are provided to the user in a graphic user interface configured as a dashboard.
